(19) United States
(12) Patent Application Publication
(10) Pub. No.: US 2011/0091605 A1
(43) Pub. Date: Apr. 21, 2011

(54) Process for extracting bioactive calcium ion

(76) Inventor: Qinghua Zhao, Shanghai (CN)

(21) Appl. No.: 12/580,224

(22) Filed: Oct. 15, 2009

(51) Int. Cl. A23L 1/28; C02F 3/34

(52) U.S. Cl. 426/61; 435/262

(57) ABSTRACT

A process for extracting a bioactive calcium ion, includes isolating calcium ion from fibrous membranes of natural shells which contain composition calcium with an extracting solution which has a temperature below 28° C. and subacidity, wherein the extracting solution comprises a protease, and utilizes water to be dispersant, such that the calcium ion chelates with dispersoid to form a colorless crystal bioactive calcium ion solution.

### BACKGROUND OF THE PRESENT INVENTION

1. Field of Invention

The present invention relates to a process for extracting calcium ion, and more particularly to a process for extracting bioactive calcium ion with biotechnology of wet method

2. Description of Related Arts

Calcium is an active metal, and exists in nature in the form of composite calcium. The composite calcium must be reduced into ionic state before being absorbed and utilized by organisms. Calcium is one of the most abundant and important elements, but is also the most lacking element in human body. In China, the average daily intake of calcium by each person is much less than the calcium intake standard of 800-1500 mg.

It has been known for long that calcium is one of the fundamental elements of human body. Calcium plays an active role in many physiological activities of human body, such as modulating muscle function, blood flow of capillary, participating in blood coagulation and nerve impulse transfer, and maintaining heart beat rate, etc. If human body is in short of calcium, many kinds of diseases may occur. For example, if a woman in pregnancy or in wet nurse lacks of calcium, it is harmful to the growth of fetus, causing unhealthy teeth and bones, poor blood coagulation, and muscle convulsion, etc. With long term lacking of calcium, children may grow with unhealthy bones, even become rickets, and elder human may have loose bones and bone hyperplasia. Lacking of calcium may also be a factor of inducing hypertension, diabetics, vascular sclerosis, and elder dementia. It is very important to provide adequate calcium supply to human since calcium can not be produced by human body and can only be absorbed from food. However, since customs, habits, feed behaviors and food structures are so widely not alike in countries and nationals, the actual daily absorption of calcium are quite different. It has been reported that lacking of calcium is a world wide problem. In many countries, calcium provided by dietary is not enough comparing to the calcium needed by a human body. In some countries, standards for daily minimum calcium supply to a human have been set up. For example, such a standard is 1,000 mg/day for an adult human, and 1,500 mg/day for junior in the United States of America. Similarly, a standard of daily calcium supply in China is 800 mg/day. However, the actual daily calcium supply in China is less than 500 mg/day due to the lacking of diary products in food structure. It has been reported that there is about 900 million people without enough calcium supply in China.

At the present, various kinds of calcium supplement products are available to human. However, these products have a poor actual absorbing rate to human. It has been known for long time that the calcium absorption is mainly occurred in human intestine. Only soluble calcium ions in intestine can be absorbed. But, since the pH in intestine is normally in the range of about 7.2-7.8, this weak basic condition makes the most calcium contained in these supplement product insoluble and can not be absorbed at all in human intestine. This phenomena often occurs with inorganic calcium, such as calcium chloride, calcium hydroxide, calcium oxide, etc. On the hand, organic calcium products, such as calcium gluconate, calcium lactate, and calcium citrate, etc. are more soluble comparing with inorganic calcium. But, the problem with these organic calcium products is that their calcium content is very low in general, about 100 mg/100 ml. Even taking large amount of these organic calcium products, the actual absorption of calcium still can not reach the needed level. However, lacking of calcium can not be observed until it becomes serious. Lacking of calcium hurts people's health quietly, and the damage is irreversible. Therefore, how to efficiently supply calcium to human body is an acknowledged problem in medicine and nutriology.

An urine calcium detection method is disclosed in Patent U.S. Pat. No. 7,407,626. We have surveyed 5000 people in community with urine calcium detection since 2000, and surprisedly found that they are lacking of calcium widely, even some people who take the calcium diets and products frequently.

Due to the fact that the population in China lack of calcium widely, there are many kinds of calcium diets and products. However, many of them are unabsorbable and have no biological value. Additionally, the calcium products do not distinguish composite calcium salt, liquid calcium, molecular calcium and ionic calcium scientifically.

Only ionic calcium is absorbable by human body, so traditional calcium diets such as calcium gluconate and calcium lactate need to be reduced in the stomach before being absorbed. However, the calcium diets stay in the stomach for only two hours, and consumes the gastric acid to reduce. As a result, most calcium is passed out of the body, and the effective absorption is therefore low. Additionally, the gluconate is bad for the diabetics, and the lactate will cause the muscle too tired.

### SUMMARY OF THE PRESENT INVENTION

An object of the present invention is to provide a process for extracting bioactive calcium ion, which achieves an bioactive calcium ion solution having high concentration at a level above 1 g/100 ml, so as to have good effective absorption and high bioavailability.

Another object of the present invention is to provide a process for extracting bioactive calcium ion, wherein the process is conducted under room temperature and therefore consumes low energy.

Another object of the present invention is to provide a process for extracting bioactive calcium ion, wherein the process adopts shells to utilize composite calcium therein, the shells do not contain poisonous materials such as Pb, Hg, or benzene, and therefore is safe and healthy.

Another object of the present invention is to provide a process for extracting bioactive calcium ion, which uses water to be effective carrier of calcium ion. Water is non-toxic, has low osmotic pressure and therefore can diffuse to be absorbed by human body.

Another object of the present invention is to provide a process for extracting bioactive calcium ion which does not need additional activating VD₃, can activate protease to adhesive albumin to act as carrier of the calcium ion, so as to be absorbed efficiently by intestinal mucosa.

Accordingly, in order to accomplish the above objects, the present invention provides a process for extracting bioactive calcium ion, comprising:

isolating calcium ion from fibrous membranes of natural shells which contain composition calcium with an extracting solution which has a temperature below 28° C. and subacidity, wherein the extracting solution contains a protease, and utilizes water to be dispersant, such that the calcium ion chelates with dispersoid to form colorless crystal calcium ion solution.

These and other objectives, features, and advantages of the present invention will become apparent from the following detailed description, and the appended claims.

### DETAILED DESCRIPTION OF THE PREFERRED EMBODIMENT

A process for extracting bioactive calcium according to a preferred embodiment of the present invention is illustrated, comprising:

isolating calcium ion from fibrous membranes of natural shells which contain composition calcium with an extracting solution which has a temperature below 28° C. and subacidity, wherein the extracting solution comprises a protease, and utilizes water to be dispersant, such that the calcium ion chelates with dispersoid to form a colorless crystal bioactive calcium ion solution.

Preferably, the extracting solution has pH of 0-5.5, and comprises 0.01%-0.5% threonine protease, 0.1%-0.8% glutamic protease, and 0.33%-0.89% serine protease, wherein the proteases are 0.2%-1% wt/wt of the extracting solution.

Preferably, the extracting has a pH of 4.0-5.5.

Preferably, the extracting has a temperature of 10° C.-25° C.

Preferably, the serine protease is selected from the group consisting of chymotrypsin, subtilisin, and fibrinolysin.

According to the present invention, the process further comprises:

filtering a remaining of the shells from the bioactive calcium ion solution with a bacteria film of 0.45μ-0.22μ.

According to the present invention, the process further comprises:

concentrating the bioactive calcium ion solution by freezing to a predetermined level for producing different calcium products.

The extracting solution may also comprise other stabilizing materials and pH adjusting materials, so as to extend storing time and fulfill different requirements.

The bioactive calcium ion solution according to the present invention has the following features:

The ion is very small, has a diameter smaller than 10⁻⁹ m, does not have interface with dispersoid particles and therefore can not block ray of light.

The bioactive calcium ion solution is a true solution which is colorless and crystal.

The calcium ion is a positive ion, can absorb proteins to be carrier to diffuse. The positive calcium ion is absorbed by negative ion such as protein group and nucleic acid group. The ion plays an important role in many cell biochemical procedures.

[symbol]

RCa (organic phase) Ca²⁺(aqueous phase)+R²⁻(organic phase)

The bioactive calcium ion solution according to the present invention has the following absorption advantages:

Calcium is a reactive metal, and can only be absorbed and utilized as an ionic form.

Water is effective carrier of calcium ion. Water is non-toxic, has low osmotic pressure and therefore can diffuse to be absorbed by human body.

The bioactive calcium ion solution does not need additional activating VD₃, can activate protease to adhesive albumin to act as carrier of the calcium ion, so as to be absorbed efficiently by intestinal mucosa.

The bioactive calcium ion solution according to the present invention has the following bioavailability advantages:

The bioactive calcium ion protein enters into blood and is carried to histiocyte, and then the calcium ion is identified by cytomembrane, passes through a membrane calcium ion pump channel for the histiocyte to utilize.

The cytomembrane ion channel is in resting potential when closing, negative ion is within the cytomembrane, and positive ion including the calcium ion is out of the cytomembrane.

The cytomembrane ion channel is in action potential when opening, positive ion including the calcium ion is within the cytomembrane, negative ion is out of the cytomembrane, and the cells are excited.

The ion channel determines function of cells and vital movement. Heartbeat, breath, glandular secretion brain thinking and body action all have close relationship with bioelectricity.

The bioactive calcium ion solution according to the present invention has the following physiological actions:

Calcium ion can activate adenosine cyclase in cells, so as to turn ATP into cyclized AMP to take physiological function. Since the important special action, calcium is also called the secondary life messenger.

Calcium ion participates in self-stable system of hormone homeostasis.

Calcium ion participates in activating various enzyme systems to accomplish biochemical reactions of metabolism.

Calcium ion maintains irritable transfer of nerve impulse and nerve muscle impulse.

Calcium ion and kalium ion are antagonistic, so as to adjust and maintain heartbeat.

Calcium ion reduces permeability of capillary vessel and cell membrane, maintains cardiovascular temper and prevents angiosclerosis.

Calcium ion participates in blood coagulation.

Calcium ion is important structural element of bones and teeth, and keeps component, normal growth and ossification of bones.

Calcium ion is released by bones, and then enters into blood to be transferred to extracellular fluid, so as to increase absorption rate of calcium ion, help homeostasis between blood calcium ion and bone calcium, and maintain integrated physiological functions.

Calcium protein carrier enters into glomerulus to be filtered, and is absorbed in renal tubules, and therefore have very high bioavailability.

Bioactive calcium ion solution adjusts immune response and resists irritability.

If metabolization of calcium ion and activating adenosine cyclase is disturbed, many physiological procedures are in chaos to cause diseases. Urine calcium detecting is an effective method to judge bioavailability of calcium ion.

The only standard to judge a calcium product is efficient absorption and high effective physiological functions. Therefore, it is urged to develop bioactive calcium ion solution which is efficiently absorbed and utilized by organism.

The calcium ion is extracted from organism with an express protein and special enzyme which is reproduced, transcribed, translated and polymerized according to biological gene code procedure, and then is synthesized into organic composite calcium having specificity: RCaCO₃ (organic phase, calcium carbonate).

It is worth mentioning that when extracting the bioactive calcium ion, physiologically valuable elements such as biological pheron and nucleic acid.

RCa (organic stable phase) [symbol] Ca²⁺H₂O(aqueous phase)+R²⁻(organic phase)

TABLE 1
protein (ultraviolet spectrometry) and nucleic acid (nucleic acid
analysis machine) in dissolvable 2.2% calcium ion solution

| detection method | Protein μg/ml | nucleic acid μg/ml |
|---|---|---|
| ultraviolet spectrometry | 37.42 | |
| nucleic acid analysis machine | | 71 |

A temperature of extracting is controlled under 28° C., so as not to lose active materials such as biological pheron and nucleic acid.

Water is H₂O, and the hydrogen bond is low-energed bond that is easy to be broken. The hydrogen bond plays an important role in vital movement, does not only participate in function of nucleic acid, but also effect property of water and configuration of protein molecule. Therefore, the bioactive calcium ion is preferably in liquid state.

The present invention adopts composite calcium in natural shell to be raw material. The resource is abundant and cheap.

The present invention controls the temperature of extracting below 28° C., so as to avoid denaturalization of the active materials such as biological pheron and nucleic acid. The process dries the calcium ion solution under 150° C.-200° C. to obtain a grey crystal powder. The active materials such as biological pheron and nucleic acid denaturalize. When the powder dissolves in water, a solution obtained is brown and has foam. Water is used as dispersant, such that the calcium ion chelates with dispersoid to form colorless crystal calcium ion solution.

After the extracting reaction, only integrated thin shell protein fibrous membranes (ossein). The extracting solution efficiently dissolves composite calcium.

The extracting solution is gentle, has no causticity. When contacting with skin, there is no cauterization, prick or heat, and therefore is safe.

The process is simple and fast, and needs only 30-60 minutes to produce the extracted calcium ion solution.

The process according to the present invention consumes low energy, has no pollution or toxicity.

Concentration of calcium extracted is high, calculated at a level of g/100 ml, much higher than traditional product.

The bioactive calcium ion solution is easy to be absorbed by human body, solving various problem about little absorption of many other calcium products on sale.

The bioactive calcium ion solution can be effectively utilized by organism. There will be long-term surviving mold after placing in natural environment for 1-2 weeks. Culturing cells in bioactive calcium ion solutions of different concentrations, the cells can survive. Therefore, the bioactive calcium ion solution can be utilized by organism efficiently.

A preferable embodiment of the process for extracting bioactive calcium ion is illustrated below.

### Environment and Equipment:

Production environment: a clean biological extracting room, a packaging room, and a purifying filling room (GMP) which is smaller than 300,000 stages.

Production equipment: washing device, water purifying device, extracting device, vacuum filtration pump, freezing drying machine, filter, ultraviolet disinfecting device, and packaging device.

Quality controlling device: pH determinator, osmotic pressure determinator, ultraviolet spectrometry, clarity determinator, degree calculator, microscope, centrifugal machine, standardized graduated flasks: 1000 ml, 500 ml, 250 ml, 100 ml, 50 ml, 20 ml, 10 ml, 5 ml, 2 ml, and 1 ml, and detecting glasswares.

Office equipment: automatic Office device, communication device, image device, server.

### Production Process

Weighing→adding shells→adding extracting solution→reacting for 1 hour→ending reaction (few shells remaining)→coarse strainer (filtering shell protein fibrous membranes)→centrifuging or filtering→bacteria film (0.45μ-0.220μ)→quality detection→freezing calcium ion solution to concentration of 2.2%, 4.4%, 8.8%→filling in production-line→packaging in production-line (automatically covering, labelling, specifying and casing)→storing after quality detection→factory inspection→leaving factory.

### Water Quality Requirement

Deionized purified water, pH 5.5-8.

### Weighing Process

Weighing organic shells precisely.

### Reaction Process

Adding weighed shells→adding extracting solution in a ½ L container (lidless reacting container), reacting for 1 hour till stable.

### Vacuum Filtration Process

Coarse filtering→fine filtering→sending the bacteria filtering membrane to quality control room.

### Quality Control Process

Quality detection items of the bioactive calcium ion solution comprise: appearance, pH, concentration, solubility, heavy metal, microorganism.

Characters: colorless, transparent liquid, no deposit, no float.

pH: original solution is between 0-7.3.

Calcium concentration: 2.2-8.8 g/100 ml. Observing concentration of calcium oxalate combined by oxalic acid liquid and calcium ion, if the concentration is too high, observing after diluting.

Solubility: there is no interface between ion and dispersoid to block light, so the solution is uniform colorless crystal liquid, the solubility is 100%.

Heavy metal: black deposit is not observed in qualitative detection by chemical method, the result is negative, conductivity is below 3.0, the national standard is that Pb <0.1 mg/L=0.01 mg/100 ml=10 PPM

Microorganism detection: culturing bacteria less than 0.2/ml, nitrite detection is negative.

Protein: 2.2% calcium ion solution (0.03742 mg/ml, 7.42 mg/ml).

Nucleic acid detection (Pharmacia Corp, GENEQUAT: 71 μg/ml)

### Freezing Process:

calcium ion solution passing detecting between batches is sent to be freezing concentrated and filled.

### Packaging Process:

filling with disinfected glass bottle or polyester bottle.

### Packaging Process:

Covering, labelling, specifying and casing.

### Quality Control:

Storing qualified product.

### Storing Condition

Storing under low temperature for 4 years, abandoning when observing turbid bacteria.

The bioactive calcium ion solution can be used as additive and added into the following:

Coca cola, verjuice, orange juice, hawthorn juice, lemon juice, tomato juice, wine, water.

The bioactive calcium ion solution can be added into the following flavoring agents:

White sugar, sodium cyclamate, honey, edible flavor, baking soda.

The bioactive calcium ion solution can be used as internal medicine:

Healthy dose: 2.4% 10 ml/bottle, twice per day, 200 ml calcium ion solution each time, can be added into milk, soup or porridge, or 2.4%, 10 ml/bottle, adding into 500-1500 drink.

Curing dose: 10 ml/bottle×40 bottles/box=220 mg (400 mg/day, for 20 days), twice per day, can be added into milk, soup or porridge.

The bioactive calcium ion solution is applicable to people of different ages and body situations.

### Additive and Style for Food:

Concentration:2.4%, 4.4%, 8.8%.

Packaging: 25 L/barrel, 5 L/barrel, 2.5 L/barrel.

Bioactive calcium ion can directly adsorb bacterial proteins, tartar protein to descale resumption of teeth, wash teeth to disinfect, resist allergy, remove bad breath; yellow protein stains can be white or other purposes. Preparations such as oral disinfectant mouthwash, tartar removal, dental calculus, tooth re-white liquid, skin whitening liquid disinfectant, cleansing liquid and other preparations can be produced.

Re-white liquid for dental calculus dirt, tea scale, tobacco scale, periodontitis, desensitization. 100 ml/bottle, twice per day, three minutes once, for one month.

Oral disinfection liquid 100 ml/bottle, twice per day, three minutes once.

Skin disinfection liquid: 100 ml/bottle, twice per day.

Face cleaning luqid: 100 ml/bottle, twice per day, local outer coating.

Yellow stains softening agent: 100 ml/bottle, washing after soaking for three minutes.

### Example 1

Adding shells into an extracting solution under 15° C. The extracting solution has a pH of 4.1, and comprises 0.03% threonine protease, 0.5% glutamic protease and 0.4% serine protease. After reacting for 45 minutes, filtering the remaining of shells, detecting the calcium ion solution obtained.

Calcium: 2.52 g/100 ml.

### Example 2

Adding shells into an extracting solution under 20° C. The extracting solution has a pH of 4.9, and comprises 0.2% threonine protease, 0.5% glutamic protease and 0.52% serine protease. After reacting for 45 minutes, filtering the remaining of shells, detecting the calcium ion solution obtained.

Calcium: 3.27 g/100 ml.

### Example 3

Preferably, the extracting solution has pH of 0-5.5, and comprises 0.01%-0.5% threonine protease, 0.1%-0.8% glutamic protease, and 0.33%-0.89% serine protease, wherein the proteases are 0.2%-1% wt/wt of the extracting solution.

Adding shells into an extracting solution under 20° C. The extracting solution has a pH of 5.3, and comprises 0.07% threonine protease, 0.2% glutamic protease and 0.7% serine protease. After reacting for 45 minutes, filtering the remaining of shells, detecting the calcium ion solution obtained.

Calcium: 3.13 g/100 ml.

According to the urine calcium detection method is disclosed in Patent U.S. Pat. No. 7,407,626, we confirmed that the bioactive calcium ion solution is highly absorbable by human body, and the bioactive calcium ion solution we produce is widely welcome by market.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A process for extracting a bioactive calcium ion, comprising:
isolating calcium ion from fibrous membranes of natural shells which contain composition calcium with an extracting solution which has a temperature below 28° C. and subacidity, wherein the extracting solution comprises a protease, and utilizes water to be dispersant, such that the calcium ion chelates with dispersoid to form a colorless crystal bioactive calcium ion solution.

2. The process, as recited in claim 1, wherein the extracting solution has pH of 0-5.5, and comprises 0.01%-0.5% threonine protease, 0.1%-0.8% glutamic protease, and 0.33%-0.89% serine protease, wherein the proteases are 0.2%-1% wt/wt of the extracting solution.

3. The process, as recited in claim 1, wherein the serine protease is selected from the group consisting of chymotrypsin, subtilisin, and fibrinolysin.

4. The process, as recited in claim 2, wherein the serine protease is selected from the group consisting of chymotrypsin, subtilisin, and fibrinolysin.

5. The process, as recited in claim 1, wherein the extracting has a pH of 4.0-5.5.

6. The process, as recited in claim 2, wherein the extracting has a pH of 4.0-5.5.

7. The process, as recited in claim 3, wherein the extracting has a pH of 4.0-5.5.

8. The process, as recited in claim 4, wherein the extracting has a pH of 4.0-5.5.

9. The process, as recited in claim 5, wherein the extracting has a temperature of 10° C.-25° C.

10. The process, as recited in claim 6, wherein the extracting has a temperature of 10° C.-25° C.

11. The process, as recited in claim 7, wherein the extracting has a temperature of 10° C.-25° C.

12. The process, as recited in claim 8, wherein the extracting has a temperature of 10° C.-25° C.

13. The process, as recited in claim 9, further comprising:
filtering a remaining of the shells from the bioactive calcium ion solution with a bacteria film of 0.45μ-0.22μ.

14. The process, as recited in claim 10, further comprising:
filtering a remaining of the shells from the bioactive calcium ion solution with a bacteria film of 0.45μ-0.22μ.

15. The process, as recited in claim 11, further comprising:
filtering a remaining of the shells from the bioactive calcium ion solution with a bacteria film of 0.45μ-0.22μ.

16. The process, as recited in claim 12, further comprising:
filtering a remaining of the shells from the bioactive calcium ion solution with a bacteria film of 0.45μ-0.22μ.

17. The process, as recited in claim 13, further comprising:
concentrating the bioactive calcium ion solution by freezing to a predetermined level for producing different calcium products.

18. The process, as recited in claim 14, further comprising:
concentrating the bioactive calcium ion solution by freezing to a predetermined level for producing different calcium products.

19. The process, as recited in claim 16, further comprising:
concentrating the bioactive calcium ion solution by freezing to a predetermined level for producing different calcium products.

20. A bioactive calcium ion solution produced by:
isolating calcium ion from fibrous membranes of natural shells which contain composition calcium with an extracting solution which has a temperature below 28° C. and subacidity, wherein the extracting solution comprises a protease, and utilizes water to be dispersant, such that the calcium ion chelates with dispersoid to form a colorless crystal bioactive calcium ion solution,
whererin the extracting solution has pH of 0-5.5, and comprises 0.01%-0.5% threonine protease, 0.1%-0.8% glutamic protease, and 0.33%-0.89% serine protease, wherein the proteases are 0.2%-1% wt/wt of the extracting solution.
